(19) United States
(12) Patent Application Publication
(10) Pub. No.: US 2006/0007201 A1
(43) Pub. Date: Jan. 12, 2006

(54) IMAGE DISPLAY CONTROLLER WITH PROCESSING DATA PROTECTION

(76) Inventor: HER-MING JONG, Hsin-Chu City (TW)

Correspondence Address: NORTH AMERICA INTELLECTUAL PROPERTY CORPORATION, P.O. BOX 506, MERRIFIELD, VA, 22116, US

(21) Appl. No.: 10/908,152

(22) Filed: Apr. 28, 2005

Related U.S. Application Data
(60) Provisional application No. 60/521,812, filed on Jul. 6, 2004.

(51) Int. Cl. G09G 5/00

(52) U.S. Cl. 345/204

(57) ABSTRACT

A method for displaying image pixel data includes measuring display device characteristics from a display device, processing the display device characteristics, encoding the processed display device characteristics to generate encoded data, storing the encoded data in the memory, decoding the encoded data stored in a memory to generate decoded data, modifying pixel data according to the decoded data to generate the image pixel data and displaying the image pixel data on the display device.

### CROSS REFERENCE TO RELATED APPLICATIONS

The application claims the benefit of U.S. Provisional Application No. 60/521,812, filed Jul. 6, 2004, and included herein by reference.

### BACKGROUND OF INVENTION

1. Field of the Invention

The present invention relates to an image display controller, and more specifically, an image display controller and its related method for protecting image processing information.

2. Description of the Prior Art

An image display system is a loosely defined entity that is usually part of a computational device such as a computer, and which handles the display of images. It is made of tangible components such as: a system controller, a display device, a video input and a display controller. The display controller is an essential part of the image display system. One of its functions is to refine raw picture data into display-ready image pixel data by using image processing information contained in an image processing data file. Please refer to FIG. 1, where this particular function of the display controller is encapsulated under the image pixel data generator 118.

FIG. 1, shows a block diagram of the components and workings of an image display system in the prior art. The end product of a development process 100 is image processing data 106, which is stored in a memory 110 inside of a system controller 108. Subsequently, a display controller 114 reads the image processing data 106 from the memory 110. At this point, the image pixel data generator 118 modifies picture data 116 according to the image processing data 106, and converts it into image pixel data 120, which is hereafter suitable for display on a display device 122.

The image processing data can be accurately explained as a set of rules or reference parameters, in the form of a software program, which handles the special characteristics of display devices and provides additional color processing functions. A proper image processing data file allows for excellent picture performance. There are two key factors in building the image processing data file. First, complex measurements and knowledge about the display device characteristics are required. Secondly, image and color processing techniques are needed.

The propensity to perform these two tasks is a specific and valuable in-house asset of display devices makers, and display controllers makers, respectively. Unfortunately, the image processing data file can be easily retrieved by anyone from the system controller's memory. Currently, there is no adequate means for the makers of display device and display controllers to guard these valuable image modification techniques. Henceforth, unscrupulous individuals or firms could appropriate this knowledge at will, which in turn would cause substantial losses to the creators of the image processing data files.

### SUMMARY OF INVENTION

It is therefore a primary objective of the claimed invention to provide an image display unit, and its related method, for modifying and displaying image pixel data in a manner that would solve the above-mentioned problems of the prior art.

According to the claimed invention, a method for displaying image pixel data on a display panel comprises decoding encoded data stored in a memory to generate decoded data, and modifying pixel data according to the decoded data to generate the image pixel data. The encoded data was gathered according to display panel characteristics and then encoded for security reason.

According to another claimed invention, a method for displaying image pixel data on a display panel comprises modifying pixel data according to encoded data stored in a memory to generate modified picture data, and decoding the modified picture data to generate the image pixel data. The encoded data was gathered according to display panel characteristics and then encoded for security reason.

According to another claimed invention, an image display unit comprises a decoder for decoding encoded data to generate decoded data, and an image pixel data generator for modifying pixel data according to the decoded data to generate image pixel data.

According to another claimed invention, an image display unit comprises a modified picture data generator for modifying pixel data according to encoded data to generate modified picture data, and a decoder for decoding the modified picture data to generate image pixel data.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a block diagram of a prior art image display system.

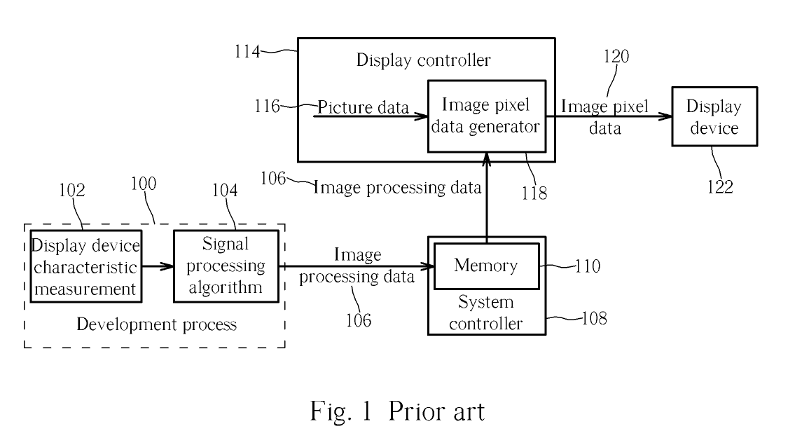

FIG. 2 is a block diagram of an image display system according to a first embodiment of the present invention.

FIG. 3 is a flowchart of a method used for displaying an image with the image display system in FIG. 2.

FIG. 4 is a block diagram of an image display system according to a second embodiment of the present invention.

FIG. 5 is a flowchart of a method used for displaying an image with the image display system in FIG. 4.

### DETAILED DESCRIPTION

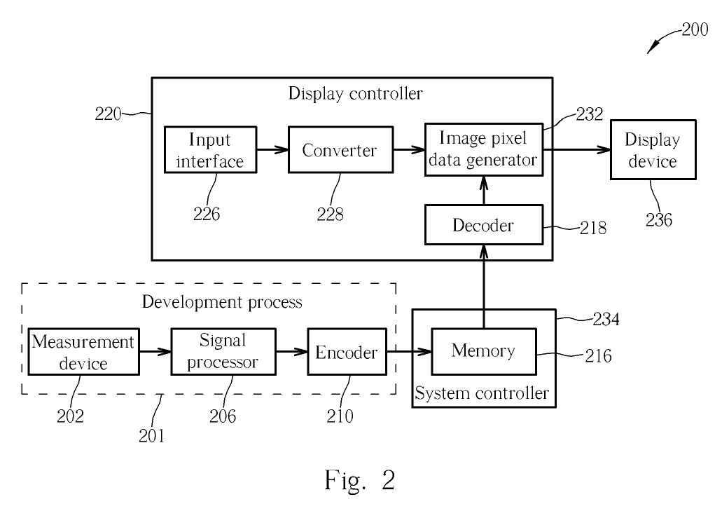

Please refer to FIG. 2. FIG. 2 depicts a block diagram of an image display system 200 according to a first embodiment of the present invention. The image display system 200 comprises a display device 236 for displaying images, a memory 216 for storing encoded data, and a display controller 220 connected to the display device 236 and the memory 216 for processing raw data according to encoded data stored in the memory 216 so as to generate image pixel data to the display device 236. The memory 216 is embedded in a system controller 234, and receives encoded data from a development process 201 which generates the encoded data according to display device characteristics measured from the display device 236.

The development process 201 is implemented by a measurement device 202 for measuring display device characteristics from a display device 236, a signal processor 206 connected to the measurement device 202 for processing display device characteristics measured by the measurement device 202, and an encoder 210 connected to the signal processor 206 for encoding display device characteristics processed by the signal processor 206 to generate encoded data.

The display controller 220 comprises a decoder 218 for decoding encoded data received from the memory 216 into decoded data, an input interface 226 for receiving raw picture data, a converter 228 connected to the input interface 226 for converting raw picture data into pixel data, and an image pixel data generator 232 connected to the converter 228, the decoder 218 and the display device 236 for modifying pixel data according to decoded data to generate image pixel data to the display device 236.

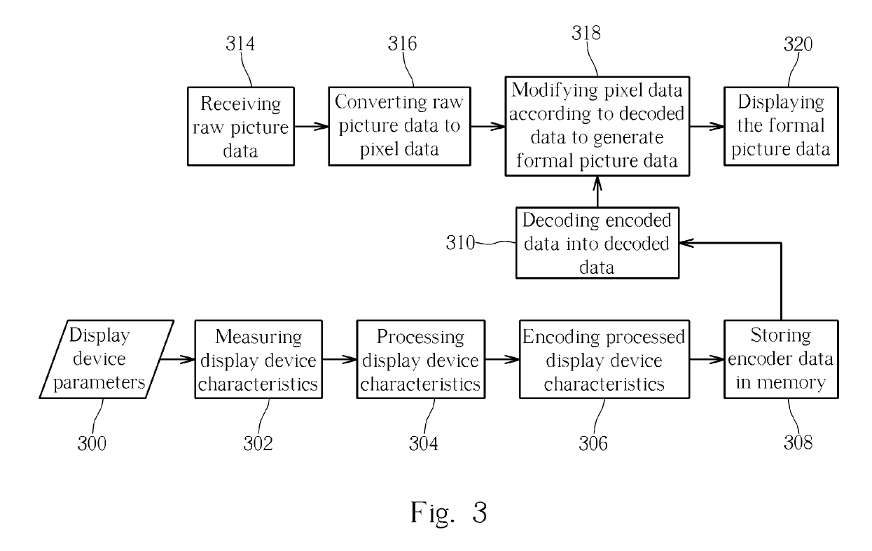

Please refer to FIG. 3. FIG. 3 depicts a flowchart diagram of using the image display system 200 to display image according to the present invention. The method of using the image display system 200 to display image comprises following steps:
Step 302: the measurement device 202 measures display device characteristics from the display device 236;
Step 304: the signal processor 206 processes display device characteristics received from the measurement device 202;
Step 306: the encoder 210 encodes display device characteristics processed by the signal processor 206 to generate encoded data;
Step 308: store the encoded data generated by the encoder 210 in the memory 216;
Step 310: the decoder 218 decodes encoded data into decoded data;
Step 314: send raw picture data to the input interface 226;
Step 316: the converter 228 converts raw picture data received from the input interface 226 into pixel data;
Step 318: the image pixel data generator 232 generates image pixel data by modifying pixel data received from the converter 228 according to decoded data received from the decoder 218; and
Step 320: the display device 236 displays the image pixel data received from the image pixel data generator 232.

Please note that the steps above are not necessarily in sequential order, due to the fact the processes which are part of the display controller 220 could be active independently of those which are part of the development process 201.

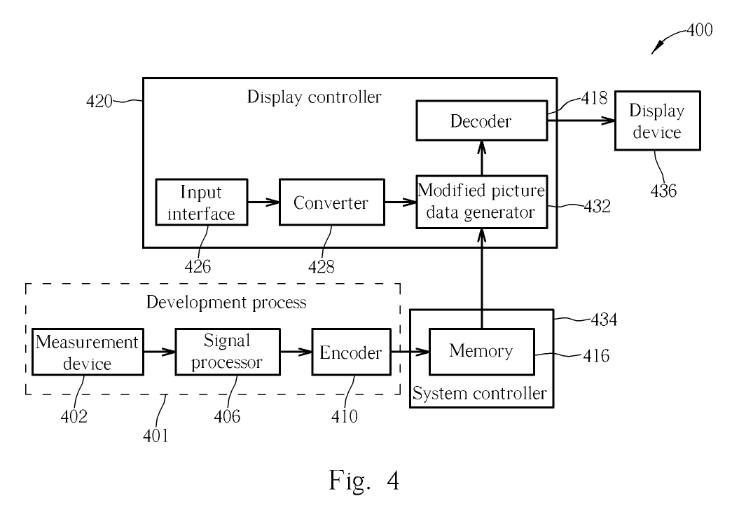

Please refer to FIG. 4. FIG. 4 depicts a block diagram of an image display system 400 according to a second embodiment of the present invention. The image display system 400 comprises a display device 436 for displaying images, a memory 416 for storing encoded data, and a display controller 420 connected to the display device 436 and the memory 416 for processing raw data according to encoded data stored in the memory 416 so as to generate image pixel data to the display device 436. The memory 416 is embedded in a system controller 434, and receives encoded data from a development process 401 which generates the encoded data according to display device characteristics measured from the display device 436.

The development process 401 is implemented by a measurement device 402 for measuring display device characteristics from a display device 436, a signal processor 406 connected to the measurement device 402 for processing display device characteristics measured by the measurement device 402, and an encoder 410 connected to the signal processor 406 for encoding display device characteristics processed by the signal processor 406 to generate encoded data.

The display controller 420 comprises an input interface 426 for receiving raw picture data, a converter 428 connected to the input interface 426 for converting raw picture data into pixel data, a modified picture data generator 432 connected to the converter 428 and memory 416 for modifying pixel data according to encoded data taken from the memory 416 to generate modified picture data, and a decoder 418 connected to the modified picture data generator 432 for decoding the modified picture data into image pixel data and to the display device 436.

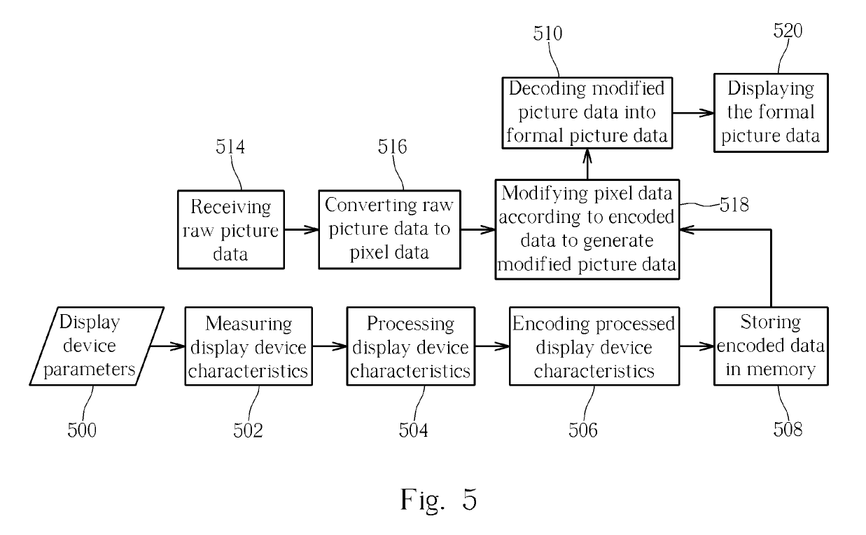

Please refer to FIG. 5. FIG. 5 depicts a flowchart diagram of using the image display system 400 to display image according to the present invention. The method of using the image display system 400 to display image comprises following steps:
Step 502: the measurement device 402 measures display device characteristics from the display device 436;
Step 504: the signal processor 406 processes display device characteristics received from the measurement device 402;
Step 506: the encoder 410 encodes display device characteristics processed by the signal processor 406 to generate encoded data;
Step 508: store the encoded data generated by the encoder 410 in the memory 416;
Step 514: the input interface 426 receives raw picture data;
Step 516: the converter 428 converts raw picture data received from the input interface 426 into pixel data;
Step 518: the modified picture data generator 432 generates modified picture data by modifying pixel data received from the converter 428 according to encoded data taken from the memory 416;
Step 510: the decoder 218 decodes the modified picture data received from the modified picture data generator 432 into image pixel data;
Step 520: the display device 436 displays the image pixel data received from the decoder 418.

Please note that the steps above are not necessarily in sequential order, due to the fact the processes which are part of the display controller 420 could be active independently of those which are part of the development process 401.

In contrast to prior art, the present invention develops an encoder software component used to encode the valuable image processing information. This information is left completely unprotected in the prior art. Moreover, by placing the encoder inside the development phase and outside the display controller itself, the current invention has no adverse effects on the operational speed and efficiency of the display controller. Additionally, since the encoder is preceded in the development phase by the execution of the signal-processing algorithm, the two can run in a correlated manner—one produces data and the other one encodes it. Henceforth, the potential hit on productivity in the development process is negligible.

Also different from the prior art is the improved display controller, which contains improved image pixel data generator, modified picture data generator and decoder. These components synergistically unite to protect the image from being freely accessed and used by parties that are not entitled to it. Due to their inherently simple nature, these components will not affect the performance of the display controller in a negative way.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for displaying image pixel data on a display panel comprising:
decoding encoded data stored in a memory to generate decoded data; and
modifying pixel data according to the decoded data to generate the image pixel data;
wherein the encoded data was gathered according to display panel characteristics.

2. The method of claim 1 further comprising displaying the image pixel data on the display device.

3. The method of claim 1 further comprising converting raw picture data to generate the pixel data.

4. The method of claim 3 further comprising receiving the raw picture data.

5. An image display unit comprising:
a decoder for decoding encoded data to generate decoded data; and
an image pixel data generator for modifying pixel data according to the decoded data to generate image pixel data.

6. The image display unit of claim 5 further comprising a memory connected to the decoder for storing the encoded data.

7. The image display unit of claim 6 wherein the memory is embedded in a system controller.

8. The image display unit of claim 5 further comprising a converter for converting raw picture data into the pixel data.

9. The image display unit of claim 8 further comprising an input interface for receiving the raw picture data.

10. The image display unit of claim 5 further comprising a display device coupled to the image pixel data generator for displaying the image pixel data.

11. An image display unit comprising:
a modified picture data generator for modifying pixel data according to encoded data to generate modified picture data; and
a decoder for decoding the modified picture data to generate image pixel data.

12. The image display unit of claim 11 further comprising a memory for storing the encoded data.

13. The image display unit of claim 12 wherein the memory is embedded in a system controller.

14. The image display unit of claim 11 further comprising a converter for converting raw picture data into the pixel data.

15. The image display unit of claim 14 further comprising an input interface for receiving the raw picture data.

16. The image display unit of claim 15 further comprising a display device coupled to the decoder for displaying the image pixel data.

17. A method for displaying image pixel data on a display panel comprising:
modifying pixel data according to encoded data stored in a memory to generate modified picture data; and
decoding the modified picture data to generate the image pixel data;
wherein the encoded data was gathered according to display panel characteristics.

18. The method of claim 17 further comprising displaying the image pixel data on the display device.

19. The method of claim 17 further comprising converting raw picture data to generate the pixel data.

20. The method of claim 19 further comprising receiving the raw picture data.
